(19) United States
(12) Patent Application Publication
(10) Pub. No.: US 2026/0211786 A1
(43) Pub. Date: Jul. 23, 2026

(54) A MONITORING DEVICE CONSIDERING RESOURCES AND A CLOUD INTEGRATED OPERATING SYSTEM COMPRISING THE SAME

(71) Applicant: OKESTRO CO., LTD., Seoul (KR)

(72) Inventors: Min Jae SONG, Seoul (KR); Chan Jae LEE, Seoul (KR); Young Gwang KIM, Seoul (KR); Min Jun KIM, Seoul (KR)

(73) Assignee: OKESTRO CO., LTD., Seoul (KR)

(21) Appl. No.: 19/142,782

(22) PCT Filed: Dec. 29, 2022
(86) PCT No.: PCT/KR2022/021675

§ 371 Date: Jun. 24, 2025

(30) Foreign Application Priority Data
Dec. 27, 2022 (KR) 10-2022-0185722
Dec. 27, 2022 (KR) 10-2022-0185763

(51) Int. Cl. G06F 11/30; G06F 11/34

(52) U.S. Cl. CPC G06F 11/301; G06F 11/3447

(57) ABSTRACT

A monitoring device according to an embodiment of the present invention is a monitoring device for monitoring an operation of at least one virtual machine operated on a physical server within allocated resources of a cloud integrated operation system and include a transmission and reception module configured to collect operating information generated in the virtual machine, a monitoring module configured to monitor whether the virtual machine operates abnormally based on the operating information collected by the transmission and reception module, a model operating module configured to operate a monitoring learning model that assists in a monitoring function of the monitoring module in response to a request from the monitoring module, and a schedule module configured to determine an operating time of the monitoring learning model through a predetermined time determination method so that the monitoring learning model can be operated within the allocated resources.

### TECHNICAL FIELD

The present invention relates to a monitoring device and a cloud integrated management system, and more particularly, to a monitoring device and a cloud-integrated management system that monitor whether a virtual machine operates normally, to operate a cloud.

### BACKGROUND ART

Recently, as a cloud market gradually grows, various services are being constructed based on a cloud, and a scale of the cloud is also growing explosively. Since it is realistically difficult for a manager to individually manage hundreds or thousands of virtual machines, technology for systematic automatic operation and management is being developed. Here, a core of an automatic operation is to implement functions necessary for a cloud operation by using a learning model through machine learning/deep learning.

The machine learning overcomes limitations of existing computer algorithms by producing a model according to its purpose by itself based on given data, unlike an existing scheme of setting all analysis algorithms. Due to such an excellent function and convenience, the machine learning is being developed and commercialized by being applied to various industrial fields.

However, in machine learning or deep learning, a lot of time and cost occurs to collect and label a large amount of data, and learning models that require a lot of resources are treated as private assets of each development company and are not disclosed but are stored and utilized internally. Accordingly, learning models with the same purpose are produced and utilized at various places, which causes a problem of social waste of resources.

Further, as the number of learning models and the amount of analysis utilized to efficiently operate the cloud increase, an operational load increases, which in turn causes a problem of not being able to efficiently manage the cloud.

### DISCLOSURE

### Technical Problem

The present invention is intended to solve the above-described problems and is directed to providing a monitoring device considering resources and a cloud integrated management system comprising the same, which improve the efficiency of a system by utilizing advanced technology.

### Technical Solution

A monitoring device according to an embodiment of the present invention is a monitoring device for monitoring an operation of at least one virtual machine operated on a physical server within allocated resources of a cloud integrated operation system, the monitoring device including: a transmission and reception module configured to collect operating information generated in the virtual machine; a monitoring module configured to monitor whether the virtual machine operates abnormally based on the operating information collected by the transmission and reception module; a model operating module configured to operate a monitoring learning model that assists in a monitoring function of the monitoring module in response to a request from the monitoring module; and a schedule module configured to determine an operating time of the monitoring learning model through a predetermined time determination method so that the monitoring learning model can be operated within the allocated resources.

Further, the monitoring learning model may include a first monitoring learning model configured to predict a load generated in the cloud integrated operation system during the predetermined future period, and the schedule module may determine the operating time based on the load predicted by the first monitoring learning model.

Further, the predetermined time determination method may be a method of determining the operating time at a time when the load is generated at or below a predetermined proportion of the allocated resources.

Further, the predetermined time determination method may be a method of determining the operating time at a time when the lowest load is generated in the predetermined future period.

Further, the monitoring device may further include a model selection module configured to select the monitoring learning model that satisfies a predetermined operating condition, wherein the predetermined operating condition may be a condition of an operation in which a load lower than a predetermined threshold is applied.

Further, the learning model may include a first monitoring learning model configured to predict a load generated in the cloud integrated operation system during the predetermined future period, and the schedule selection module may change the predetermined threshold based on the load predicted by the first monitoring learning model.

A cloud integrated operation system according to an embodiment of the present invention includes a management device configured to manage a virtual machine operated on a physical server; a monitoring device configured to monitor an operation of the virtual machine; and a learning model recommendation device configured to recommend a monitoring learning model required for the monitoring device to implement a monitoring function, the monitoring device includes a transmission and reception module configured to collect information generated in the virtual machine, a monitoring module configured to monitor whether the virtual machine operates abnormally based on the information of the virtual machine collected by the transmission and reception module, a model operating module configured to operate the monitoring learning model that assists in a monitoring function of the monitoring module in response to a request from the monitoring module, a schedule module configured to determine an operating time of the monitoring learning model through a predetermined time determination method so that the monitoring learning model can be operated within allocated resources, and a model selection module configured to select the monitoring learning model that is operated in the model operating module that satisfies predetermined operation conditions, the model selection module requests the learning model recommendation device to recommend the monitoring learning model that satisfies the predetermined operation conditions, and the learning model recommendation device recommends a learning model that satisfies predetermined recommendation conditions under which a pre-stored learning model is similar to the monitoring learning model with a degree of similarity equal to or higher than a first degree of similarity among pre-stored learning models.

Further, the learning model recommendation device may recommend a learning model that satisfies a first predetermined additional condition determined to be satisfied based on a second degree of similarity lower than the first degree of similarity or a second predetermined additional condition determined to be satisfied based on a virtual learning model created by combining a plurality of stored learning models, even when there is no learning model satisfying the pre-stored learning model among the pre-stored stored learning models.

Further, the first predetermined additional condition may be a condition under which the stored learning model is similar to the monitoring learning model with a degree of similarity equal to or higher than the second degree of similarity and lower than the first degree of similarity, and the number of clusters of pre-stored learning models similar to the monitoring learning model with a degree of similarity lower than the second degree of similarity is equal to or smaller than a predetermined number.

A monitoring method according to an embodiment of the present invention is a monitoring method for monitoring an operation of at least one virtual machine operated on a physical server within allocated resources of a cloud integrated operation system through a monitoring device, the monitoring method including: collecting, by a transmission and reception module, operating information generated in the virtual machine; monitoring, by a monitoring module, whether the virtual machine operates abnormally based on the operating information; operating, by a model operating module, a monitoring learning model that assists in a monitoring function of the monitoring module in response to a request from the monitoring module; and determining, by a schedule module, an operating time of the monitoring learning model through a predetermined time determination method so that the monitoring learning model can be operated within allocated resources.

A learning model recommendation device according to an embodiment of the present invention may be a learning model recommendation device that recommends a learning model produced by machine learning or deep learning in response to a request from a demander, and may include a reception module that receives a request from the demander and production conditions for a target learning model which is a learning model requested by the demander, a storage module that stores stored learning models which are learning models produced in the past, and production conditions for the stored learning model, a degree-of-similarity determination module that determines a degree of similarity between the target learning model and the stored learning model, and a recommendation module that recommends to the demander the learning model satisfying a predetermined recommendation condition among the stored learning models stored in the storage module as a recommended learning model, and the predetermined recommendation condition may be a condition similar to the target learning model with a degree of similarity equal to or higher than a first degree of similarity.

Further, even when the predetermined recommendation condition is not satisfied, the recommendation module may produce the recommended learning model according to a predetermined production method when the first predetermined additional condition is satisfied, and the first predetermined additional condition may be a condition under which the stored learning model is similar to the target learning model with a degree of similarity equal to or higher than the second degree of similarity and lower than the first degree of similarity, and the number of clusters of stored learning models similar to the target learning model with a degree of similarity lower than the second degree of similarity is equal to or smaller than a predetermined number.

Further, the predetermined production method may be a method of selecting the stored learning model closest to an average of the cluster as the recommended learning model when there is one cluster of stored learning models similar to the target learning model with a degree of similarity equal to or higher than the second degree of similarity.

Further, the predetermined production method may be a method of selecting the recommended learning model as a combination of the stored learning models closest to an average of each cluster when the number of clusters of the stored learning models similar to the target learning model with a degree of similarity equal to or higher than the second degree of similarity is larger than 1 and equal to or smaller than a predetermined number.

Further, the recommendation module may select the recommended learning model based on the stored learning models that satisfy the second predetermined additional condition even when the predetermined recommendation condition and the first predetermined additional condition are not satisfied, and the second predetermined additional condition may be a condition under which the degree of similarity to the target learning model is equal to or higher than the first degree of similarity when the stored learning models similar to the target learning model with a degree of similarity lower than the second degree of similarity are connected.

Further, a simulation module that simulates a state of a final learning model when arbitrary learning models are connected to each other may be further included, and the simulation module may produce, through deep learning, a simulation model that calculates a state of a final learning model, when a plurality of learning models are input to the simulation model.

Further, a learning proposal module configured to propose creation of a learning model to a manager when the predetermined learning conditions are satisfied may be further included, and the predetermined learning condition may be a condition under which the predetermined recommendation condition is not satisfied.

Further, a price calculation module that calculates a cost to be charged while recommending the stored learning model may be further included, and the price calculation module may calculate the cost to be charged based on a degree of similarity between the target learning model and the recommended learning model to be recommended

A learning model recommendation method according to an embodiment of the present invention is implemented by a learning model recommendation device, and is a learning model recommendation method of recommending a learning model produced by machine learning or deep learning in response to a request from a demander and may include a request receiving step of receiving, by a reception module, a request from the demander and production conditions for a target learning model, which is a learning model requested by the demander, a condition storage step of storing, by a storage module, a stored learning model which is a learning model created in the past and production conditions for the stored learning model, a degree-of-similarity determination step of determining, by a degree-of-similarity determination module, a degree of similarity between the target learning model and the stored learning model, and a recommendation step of recommending, by a recommendation module, a learning model satisfying a predetermined recommendation condition among the stored learning models stored in the storage module to the demander, wherein the predetermined recommendation condition may be a condition under which the stored learning model is similar to the target learning model with a degree of similarity equal to or higher than a first degree of similarity.

Further, the recommendation step may be a step of selecting or producing a learning model to be recommended to the demander by determining whether a first predetermined additional condition determined to be satisfied based on a second degree of similarity lower than the first degree of similarity and a second predetermined additional condition determined to be satisfied based on a virtual learning model created by combining a plurality of stored learning models are satisfied, even when the pre-stored learning model is not satisfied.

### Advantageous Effects

With the monitoring device considering resources and the cloud integrated management system comprising the same according to the present invention, it is possible to reduce social resource costs.

Further, it is possible to efficiently operate the system.

Further, it is possible to greatly shorten a development time.

Further, it is possible to prevent an overload of the system.

However, the effects of the present invention are not limited to the above-described effects, and effects that are not mentioned can be clearly understood by those skilled in the art to which the present invention belongs from the present specification and the accompanying drawings.

### DESCRIPTION OF DRAWINGS

FIG. 1 is a relationship diagram of a cloud integrated operation system according to an embodiment of the present invention.

FIG. 2 is a configuration diagram of the cloud integrated operation system according to the embodiment of the present invention.

FIG. 3 is a configuration relationship diagram of a monitoring device of the cloud integrated operation system according to the embodiment of the present invention.

FIG. 4 illustrates a flowchart showing a learning model recommendation method implemented by a learning model recommendation device of the cloud integrated operation system according to the embodiment of the present invention.

FIG. 5 is a diagram illustrating a predetermined recommendation condition and a first predetermined additional condition in the learning model recommendation method according to the embodiment of the present invention.

FIG. 6 is a diagram illustrating a learning model mediation interface screen that is provided by an interface module of the learning model recommendation device according to the embodiment of the present invention.

FIG. 7 is a flowchart illustrating a process in which the learning model recommendation device according to the embodiment of the present invention selects the learning model to be recommended to the monitoring device.

FIG. 8 is a diagram illustrating a method in which a model selection module of the monitoring device according to the embodiment of the present invention calculates a first operating time and a second operating time.

### MODE FOR DISCLOSURE

Hereinafter, specific embodiments of the present invention will be described in detail with reference to the drawings. However, the spirit of the present invention is not limited to the presented embodiments, and those skilled in the art who understand the spirit of the present invention can easily propose other regressive inventions or other embodiments included within the scope of the spirit of the present invention by, for example, adding, changing, and deleting other components within the scope of the same spirit, which are included within the scope of the spirit of the present invention.

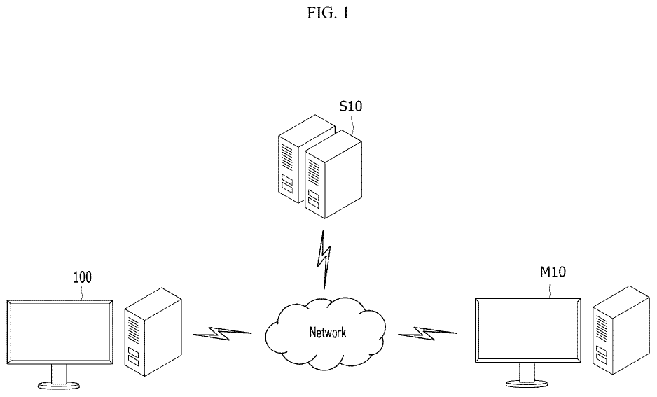

FIG. 1 is a relationship diagram of the cloud integrated operation system according to the embodiment of the present invention.

Referring to FIG. 1, a cloud integrated operation system 10 according to an embodiment of the present invention may be a system that manages and operates a virtual machine operated on a physical server, sells and rents learning models required by cloud users (demanders), and provides cloud services.

To this end, the cloud integrated operation system 10 may be connected to a demander M10 and a physical server S10 via a wired/wireless network to transmit and receive necessary information.

For example, a demander M10 may be a person who receives a virtualized cloud service.

For example, the demander M10 may transmit conditions and a request for a learning model that the demander wishes to purchase or rent to a learning model recommendation device, and the learning model recommendation device may provide the demander with the learning model, an interface for requesting, transmitting, and receiving the learning model, and the like.

The cloud integrated operation system 10 may be a system that recommends a necessary cloud service or learning model in response to a request from the demander client when there is the request.

Further, the learning model recommendation method may provide an interface so that the learning model can be used in a cloud environment.

A network in the present invention may be a core network integrated with a wired public network, a wireless mobile communication network, or a mobile Internet, may mean a global open computer network structure that provides various services existing in TCP/IP protocol and a higher-level layer, such as hyper text transfer protocol (HTTP), hyper text transfer protocol secure (HTTPS), Telnet, file transfer protocol (FTP), domain name system (DNS), simple mail transfer protocol (SMTP), or the like, the present invention is not limited to such an example, but the network comprehensively means a data communication network on which data can be transmitted and received in various forms.

Hereinafter, the cloud integrated operation system will be described in detail.

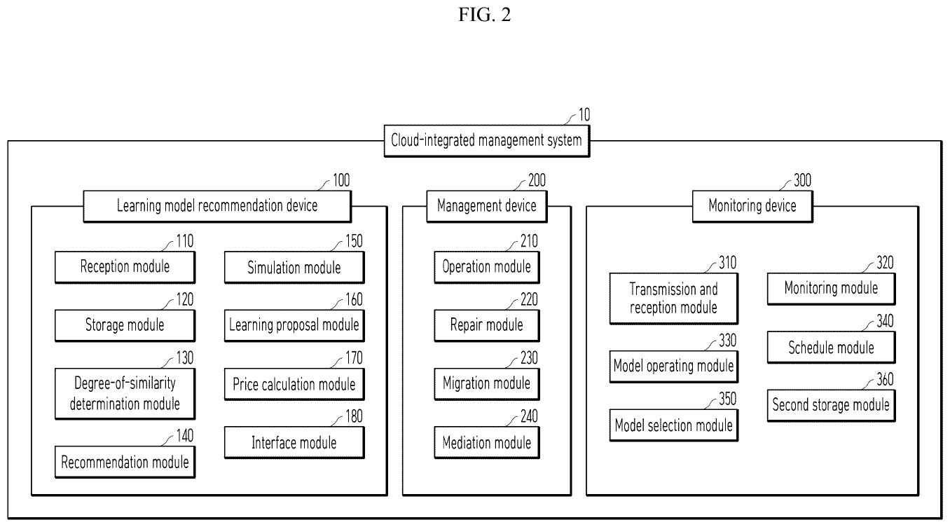

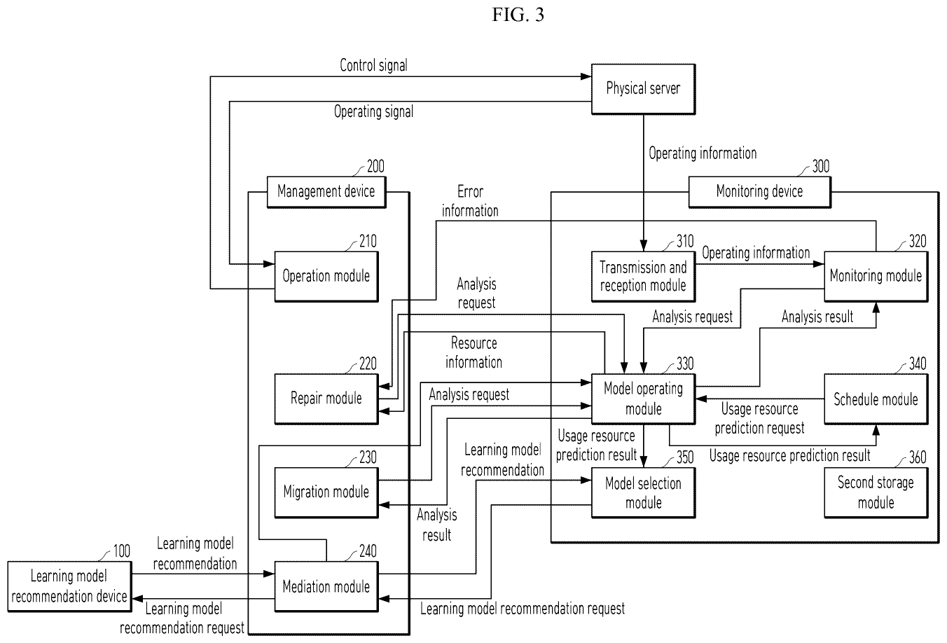

FIG. 2 is a configuration diagram of the cloud integrated operation system according to the embodiment of the present invention, and FIG. 3 is a configuration relationship diagram of a monitoring device of the cloud integrated operation system according to the embodiment of the present invention.

Referring to FIGS. 2 and 3, the cloud integrated operation system according to the embodiment of the present invention includes a learning model recommendation device 100 that recommends a learning model in response to a request from the demander, a management device that manages the virtual machine operated on the physical server, and a monitoring device that monitors an operation of the virtual machine.

Hereinafter, each device will be described in detail.

The learning model recommendation device 100 according to the embodiment of the present invention may be a learning model recommendation device 100 that recommends a learning model produced by machine learning or deep learning in response to a request from a demander, and includes a reception module 110 that receives a request from a demander and production conditions for a target learning model which is a learning model requested by the demander, a first storage module 120 that stores stored learning models which are learning models produced in the past, and production conditions for the stored learning model, a degree-of-similarity determination module 130 that determines a degree of similarity between the target learning model and the stored learning model, and a recommendation module 140 that recommends to the demander the learning model satisfying a predetermined recommendation condition among the stored learning models stored in the first storage module 120 as a recommended learning model.

Further, the learning model recommendation device 100 may further include a simulation module 150 that simulates a state of a final learning model when arbitrary learning models are connected to each other.

Further, the learning model recommendation device 100 may further include a learning proposal module 160 configured to propose creation of a learning model to the manager when the predetermined learning conditions are satisfied.

Further, the learning model recommendation device 100 may further include a price calculation module 170 that calculates a cost to be charged while recommending the stored learning model.

Further, the learning model recommendation device 100 may further include an interface module 180 that produces and transmits an interface that can display and collect information required for implementation of the learning model recommendation method on a computing device of the manager or demander.

The reception module 110 may collect the information required for implementation of the learning model recommendation method.

For example, the reception module 110 may receive request information and production conditions, which are the conditions of the learning model required by the demander, from the demander.

The demander may input a learning model request and the production conditions through the interface provided by the interface module 180 using the computing device of the demander.

The production conditions may include a learning purpose of a learning model, a type of production object, a learning method, a type of learning model, an amount of learning data, a type of learning data, a learning time, and the like.

The learning purpose may be a purpose or task to be solved by the learning model.

For example, the learning purpose may be a purpose of identifying a person based on video data, a purpose of identifying lung cancer based on X-RAY data, and the like.

However, the present invention is not limited thereto, and a type of learning purpose can be changed in various ways at a level that is obvious to those skilled in the art.

The type of production object may refer to a specific meaning of a result value.

For example, the type of production object may indicate “person or not person”, “lung cancer or not lung cancer”, “a predetermined treatment method”, and the like.

However, the present invention is not limited thereto, and the type of production object can be changed in various ways at a level that is obvious to those skilled in the art.

The learning method may be a method of performing machine learning and/or deep learning on the learning model.

For example, the learning method may be classified into deep learning and machine learning.

Further, the learning method may be classified into supervised learning, unsupervised learning, and reinforcement learning.

The type of learning model may be a specific type of algorithm that is used for learning.

For example, the types of learning model may be classified into k-nearest neighbor algorithm (K-NN), a support vector machine algorithm (SVM), a decision tree algorithm, a random forest algorithm, and the like.

For example, the types of learning model may be classified into ANN, CNN, DNN, GAN, and RNN.

However, the present invention is not limited thereto, and the types of learning model can be changed in various ways at a level that is obvious to those skilled in the art.

The amount of learning data may be an amount of data required for creation of a learning model.

For example, the amount of learning data may be expressed in a value and unit that express the amount of data, such as GB and TB.

The type of learning data may include a form of an image, text, or video.

The learning time may be a time required for machine learning/deep learning.

However, the present invention is not limited thereto, and the production conditions can be changed in various ways at a level that is obvious to those skilled in the art.

The reception module 110 may transfer the received information to other modules including the degree-of-similarity determination module 130.

The reception module 110 may receive information required for operating the learning model recommendation method and the learning model mediation platform.

The first storage module 120 may store all pieces of information required for implementation of the learning model recommendation method.

The first storage module 120 may store the stored learning models, which are learning models learned in the past, and the production conditions for the stored learning model in a matched manner.

The first storage module may include an internal memory and/or an external memory.

For example, the internal memory may include at least one of a volatile memory (for example, DRAM, SRAM, or SDRAM), a nonvolatile memory (for example, one time programmable ROM (OTPROM), a PROM, an EPROM, an EEPROM, a mask ROM, a flash ROM, a flash memory, a hard drive, or a solid state drive (SSD)).

The external memory may include a flash drive, for example, a compact flash (CF), a secure digital (SD), a micro-SD, a mini-SD, an extreme digital (xD), a multi-media card (MMC), or a memory stick.

The degree-of-similarity determination module 130 may be a model that determines the degree of similarity between the target learning model and the stored learning model.

The degree-of-similarity may be calculated by comparing the production conditions for the target learning model and the production conditions for the stored learning model.

The degree-of-similarity determination module 130 may preprocess and vectorize the production conditions for the stored learning model. Since a vectorization method is a known technology, detailed description thereof may be omitted.

Similarly, the degree-of-similarity determination module 130 may preprocess and vectorize the production conditions for the target learning model.

The degree-of-similarity determination module 130 may compare the production conditions for the target learning model with those for the target learning model to calculate the degree of similarity.

For example, the degree-of-similarity determination module 130 may calculate the degree of similarity based on a distance between vector information of the production conditions for the target learning model and vector information of the production conditions for the stored learning model.

However, the present invention is not limited thereto, and a method of determining a degree of similarity in the degree-of-similarity determination module 130 may be changed in various ways at a level that is obvious to those skilled in the art.

The recommendation module 140 may determine whether the predetermined recommendation condition, the first predetermined additional condition, and the second predetermined additional condition are satisfied to select the recommended learning model.

The predetermined recommendation condition may be a condition under which the stored learning model is similar to the target learning model with a degree of similarity equal to or higher than a first degree of similarity.

When the distance from the target learning model is smaller than or equal to a first distance, it may be determined that the models are similar to the first degree of similarity or higher.

The first predetermined additional condition may be a condition under which the stored learning model is similar to the target learning model with a degree of similarity equal to or higher than the second degree of similarity and lower than the first degree of similarity, and the number of clusters of stored learning models similar to the target learning model with a degree of similarity lower than the second degree of similarity is equal to or smaller than a predetermined number.

When the distance from the target learning model is greater than the first distance and smaller than or equal to a second distance, it may be determined that the models are similar with a degree of similarity equal to or higher the second degree of similarity and lower than the first degree of similarity.

Here, the second distance may mean a distance longer than the first distance.

Here, the predetermined number of clusters may be 3.

However, the present invention is not limited thereto, and the predetermined number of clusters may be changed in various ways at a level that is obvious to those skilled in the art.

The second predetermined additional condition may be a condition under which the degree of similarity to the target learning model is equal to or higher than the first degree of similarity when stored learning models similar to the target learning model with a degree of similarity lower than the second degree of similarity are connected.

When the distance from the target learning model exceeds the second distance, it may be determined that the models are similar to a degree of similarity lower than the second degree of similarity.

The stored learning model itself is similar to the target learning model with a degree of similarity lower than the second degree of similarity, but when several stored learning models are combined, the stored learning model may be similar to the target learning model with the first degree of similarity or higher.

For example, it may be assumed that the target learning model is a model that identifies an intruder based on video data and calculates a countermeasure based on a type of intrusion. A first stored learning model may be a learning model that identifies an intruder based on video data, a second stored learning model may be a learning model that determines a form of intrusion based on the video data, and a third stored learning model may be a model that produces a countermeasure based on a type and form of the intrusion. Each of the first to third stored learning models is similar to the target learning model with a degree of similarity lower than the second degree of similarity, but a combination of the first to third stored learning models may be similar to the target learning model with the first degree of similarity or higher.

This makes it possible to recommend a learning model that satisfies the needs of the demander by fully utilizing the stored learning modules stored in the storage module 120.

The simulation module 150 may connect the stored learning modules stored in the storage module 120 to create a virtual learning model.

When the predetermined recommendation condition and the first predetermined additional condition described above are not satisfied, the simulation module 150 may receive the production conditions for the target learning model from the reception module 110 and receive all pieces of information on the stored learning models from the storage module 120.

The simulation module 150 may combine the stored learning modules based on data input to the target learning model and data output from the target learning model.

As a specific example, the simulation module 150 may select a stored learning model in which input data input to the target learning model matches input data input to the stored learning model (a start stored learning model).

Further, the simulation module 150 may select a stored learning model (end stored learning model) in which the output data output from the target learning model matches the output data of the stored learning model.

Here, the matching may mean that a format of input data at least partially matches the purpose of data analysis.

Further, the simulation module 150 may select a stored learning model (intermediate stored learning model) that uses data matching output data of the start stored learning model as input data and data matching input data of the end stored learning model as output data.

There may be no intermediate stored learning model, there may be one intermediate stored learning model, or there may be a plurality of intermediate stored learning models. When there may be the plurality of intermediate stored learning models, output data of a preceding intermediate stored learning model and input data of a succeeding intermediate stored learning model may be aligned so that the data match each other, and the simulation module 150 may select the intermediate stored learning model so that input data of the most preceding intermediate stored learning model matches output data of the start stored learning model and output data of the most succeeding intermediate stored learning model matches input data of the end stored learning model.

The simulation module 150 may produce, through machine learning/deep learning, a simulation model that calculates a state of a final learning model when a plurality of learning models are input to the simulation model.

For the machine learning, a back propagation algorithm that updates a weight of a neural network using labeled data of an output layer may be used, but the present invention is not limited thereto.

Further, since a deep neural network and the back propagation algorithm are known, detailed description thereof may be omitted.

The start stored learning model, the end stored learning model, and/or the intermediate stored learning model selected by the simulation module 150 may be input to the simulation model so that a virtual learning model can be produced.

Further, the simulation module 150 may calculate production conditions for the virtual learning model based on the stored learning models input to the simulation model.

For example, the learning time may be calculated as a sum of learning times of the stored learning models input to the simulation model.

For example, an amount of learning data may be calculated as a sum of the stored learning models input to the simulation model.

The simulation module 150 may not be able to produce the production conditions for the virtual learning model that cannot be estimated as the stored learning model.

The degree-of-similarity determination module 130 may determine a degree of similarity between the virtual learning model and the target learning model based only on the calculated production conditions when determining the degree of similarity.

The learning proposal module 160 may propose that the manager creates the learning model when the predetermined learning conditions are satisfied.

The predetermined learning conditions may be conditions under which the predetermined recommendation condition are not satisfied.

As a specific example, the predetermined learning conditions may be conditions under which there are a predetermined number or more of similar target learning models that do not satisfy the predetermined recommendation condition, the first predetermined additional condition, and the second predetermined additional condition.

The learning proposal module 160 may receive production conditions of the target learning model that does not satisfy the predetermined recommendation conditions, the first predetermined additional condition, and the second predetermined additional condition (hereinafter referred to as a rejected learning model) from the recommendation module 140, and store the rejected learning model.

The learning proposal module 160 may vectorize and cluster the production conditions of the rejected learning model.

Since a method of clustering data is a known technology, detailed description thereof may be omitted.

When a clustered group includes rejected learning models of which the number is equal to or larger than a predetermined number, the learning restriction module may reconstruct a vector value of an average of the group and propose that the manager creates the learning model with the calculated production conditions.

To this end, the interface module 180 may produce an interface for displaying the production conditions for proposing learning to the manager and prompting for approval.

The price calculation module 170 may calculate a cost related to using, selling, or licensing the stored learning model in a cloud environment.

The price calculation module 170 may calculate a cost based on the difficulty of producing the stored learning model.

For example, the price calculation module 170 may set a higher cost as the manufacturing difficulty increases. On the other hand, the price calculation module 170 may set a lower cost as the manufacturing difficulty decreases.

The price calculation module 170 may calculate a cost to be charged based on the degree of similarity between the target learning model and the recommended learning model to be recommended.

Here, the degree of similarity may be calculated based on a distance between the two models.

This makes it possible for the demander to be compensated for any disadvantage caused due to the inability to use a desired learning model.

The interface module 180 may produce an interface capable of displaying or collecting information required by the manager or the demander as the learning model recommendation method is implemented, and provide the interface to the computing device of the manager or the demander.

The interface module 180 may produce an interface for a learning model mediation platform that enables buying and selling of the learning models, and provide the interface to a buyer or seller.

Detailed description of the learning model mediation platform will be described below.

The interface module 180 may transmit information required for an operation of the learning model recommendation method and the learning model mediation platform.

The interface module 180 may transfer, to the seller of the learning model, the production conditions for which the manager rejects a learning request.

A seller list for the learning model may include sellers which use the learning model mediation platform.

This makes it possible to activate a learning model platform and a learning model sales market and satisfy needs of the demanders.

The learning model recommendation device can not only recommend learning models required inside the system to other devices inside the system, but also recommend appropriate learning models to cloud service users or individual Internet users.

A management device 200 according to an embodiment of the present invention may include an operating module 210 that operates a virtual machine of a physical server, a repair module 220 that corrects an error when the virtual machine operates abnormally, a migration module 230 that derives and migrates an optimal disposition of the virtual machine on the physical server, and a mediation module 240 that intermediates the learning model recommendation device and the monitoring device 300.

The operating module 210 may perform operations such as creating and deleting the virtual machine in response to a request from a user.

The repair module 220 may repair the virtual machine using a predetermined repair method when an error occurs in the virtual machine.

The repair module 220 may store a database of countermeasures depending on errors. The repair module 220 may receive a log and metadata of the virtual machine causing an error from the monitoring device 300, and correct the error of the virtual machine by using the pre-stored response method.

However, the prevent invention is not limited thereto, and the repair method of the repair module 220 can be changed in various ways at a level that is obvious to those skilled in the art.

For example, the repair module 220 may request the model operating module 330 to produce an appropriate repair method depending on the error. Accordingly, one monitoring learning model stored in the model operating module 330 may be operated to produce an appropriate repair method depending on the error, and the derived repair method may be transferred from the model operating module 330 to the repair module 220.

The migration module 230 may migrate the virtual machine in order to dispose the virtual machine on physical machine.

For example, the migration module 230 may request the model operating module 330 to predict a workload of the virtual machine, and one monitoring learning model stored in the model operating module 330 may be operated to derive a workload predicted to occur in the cloud service. The workload of the virtual machine predicted by the model operating module 330 may be transferred to the migration module 230, and the migration module 230 may derive an optimal disposition of the virtual machine in which minimizes a pre-designated objective function is minimized based on the predicted workloads of the virtual machines, so that the virtual machine can be disposed on the physical server.

Therefore, detailed description thereof may be omitted within the scope of known technology.

The mediation module 240 may mediate between the monitoring device 300 and the learning model recommendation device so that the monitoring device 300 can appropriately receive a necessary learning model recommended by the learning model recommendation device.

The mediation module 240 may be associated with the monitoring device 300 to receive information required by the operating module 210, the repair module 220, and the migration module 230 from the monitoring device 300.

However, the present invention is not limited thereto, and the monitoring device 300 may directly communicate with the learning model recommendation device to exchange information required for learning model recommendation.

The monitoring device 300 according to an embodiment of the present invention may be a monitoring device 300 that monitors an operation of at least one virtual machine operating on a physical server within allocated resources of a cloud server integrated management system, and may include a transmission and reception module 310 that collects operating information generated from the virtual machine, a monitoring module 320 that monitors whether the virtual machine operates abnormally based on the operating information collected by the transmission and reception module 310, a model operating module 330 that operates a monitoring learning model that assists in a monitoring function of the monitoring module 320 in response to a request from the monitoring module 320, and a schedule module 340 that determines an operating time of the monitoring learning model through a predetermined time determination method so that the monitoring learning model can be operated within the allocated resources.

Further, the cloud server integrated management system may further include a model selection module 350 that selects the monitoring learning model that satisfies predetermined operation condition.

Further, the cloud server integrated management system may further include a second storage module 360 that stores all pieces of information required for implementation of the monitoring method.

The transmission and reception module 310 may collect operating information generated from the virtual machine.

Further, the transmission and reception module 310 may transmit and receive information required for implementation of the monitoring method to and from an external server, a client, and internal components of the cloud server integrated management system.

For example, the operating information may include both metric data and log data generated from the virtual machine.

The monitoring module 320 may monitor in real time whether the virtual machine operates abnormally based on the operating information.

To this end, the monitoring module 320 may store error patterns of operating information that may be determined to be abnormal, and when a similar error pattern is detected, it may be determined that an error has occurred in a virtual machine.

The monitoring module 320 may transfer information on the virtual machine in which an error has occurred to the management device 200.

The monitoring module 320 may produce an interface for displaying information on a load generated in the virtual machine, a load status of the physical server, a list of physical servers in operation, and the like to a manager of the cloud server integrated management system.

Further, the monitoring module 320 may produce an interface that can allow the demander to check a usage status of the virtual machine, an incurred cloud usage cost, and the like.

Here, the interface may be represented through a visual image such as a graph.

The monitoring function in the present invention may include a function of producing, detecting, monitoring, and predicting all pieces of information generated in the cloud service, such as detection of abnormal symptom in the virtual machine, prediction of a load of the virtual machine, prediction of a load of the cloud integrated operation system, an amount of power generated in the physical server, and detection of abnormal symptom in the physical machine.

The model operating module 330 may operate the monitoring learning model which is a learning model that assists in the operation of the management device 200 or the monitoring function of the monitoring module 320.

For example, the monitoring learning model may include a first monitoring learning model that predicts a load generated in the cloud server integrated management system during a predetermined future period.

For example, the monitoring learning model may include a second monitoring learning model that predicts a workload generated in the virtual machine on the physical server during the predetermined future period.

For example, the predetermined future period may be 30 days.

However, the present invention is not limited thereto, and the predetermined future period may be changed in various ways at a level that is obvious to those skilled in the art.

For example, the monitoring learning model may include a third monitoring learning model that determines whether there is an error in the virtual machine through the operating information and produces a solution to resolve the error.

The model operating module 330 stores the monitoring learning model.

The model selection module 350 may select the monitoring learning model that satisfies the predetermined operation conditions and transfer the selected monitoring learning model to the model operating module 330.

The predetermined operating condition may be a condition for operation in which a load lower than a predetermined threshold is applied.

The model selection module 350 may change the predetermined threshold based on the load predicted by the first monitoring learning model.

The model selection module 350 may receive information on usage resources among all resources of the cloud integrated operation system during a predetermined period stored in the storage module in order to calculate the predetermined threshold.

On the other hand, the model selection module 350 may receive information on spare resources of the cloud integrated operation system during the predetermined future period through the first monitoring learning model of the model operating module 330.

Here, the spare resources may be resources obtained by subtracting usage resources from the total resources.

For example, the predetermined threshold may be 70% of average spare resources during a future period or a predetermined period.

However, the present invention is not limited thereto, and an exact value of the predetermined threshold can be changed in various ways at a level that is obvious to those skilled in the art.

The model selection module 350 may request the learning model recommendation device to recommend the monitoring learning model that satisfies the predetermined operation conditions.

When the model selection module 350 requests the learning model recommendation device to recommend a required monitoring learning model, the model selection module 350 may transmit production conditions for the monitoring learning model together.

The model selection module 350 may receive a monitoring learning model (recommended learning model) from the learning model recommendation device and transfer the monitoring learning model to the model operating module 330, and the model operating module 330 may store the monitoring learning model.

The schedule module 340 may determine the operating time based on the load predicted by the first monitoring learning model.

Here, the operating time may be a term that includes not only a starting point but also a duration.

For example, the predetermined time determination method may be a method of determining the operating time at a time when the load is generated at or below a predetermined proportion of resources allocated to the cloud integrated operation system.

As a specific example, the schedule module 340 may divide the predetermined future period into predetermined partition periods.

Here, the partition periods may be in units of hours, days, or weeks.

Here, the schedule module 340 may calculate average usage resources expected to be generated in the cloud integrated operation system for each partition period.

The schedule module 340 may determine that a period in which usage resources calculated for each partition period is equal to or lower than a predetermined proportion of the total resources is the operating time.

Here, the predetermined proportion (first proportion) may be 10%.

However, the present invention is not limited thereto, and the predetermined proportion may be changed in various ways at a level that is obvious to those skilled in the art.

As an example, the predetermined time determination method may be a method of determining the operating time at a time when the lowest load is generated in the predetermined future period.

As a specific example, the schedule module 340 may divide the predetermined future period into predetermined partition periods.

Here, the partition period may be in units of minutes, hours, days, or weeks.

Here, the schedule module 340 may calculate the average usage resources generated in the cloud integrated operation system for each partition period.

The schedule module 340 may determine that a partition period in which an amount of average usage resources calculated for each partition period is smallest is the operating time.

The schedule module 340 can effectively solve the problem that an operating rate of the cloud integrated operation system is hindered by an operation of the operating learning model, by selecting and determining that a time when the load of the cloud integrated operation system is low is the operating time.

The second storage module 360 may store all the pieces of information required for implementation of the monitoring method.

The second storage module 360 may also store past entire resource information of the cloud integrated operation system, past usage resource information, and the like.

The second storage module may include an internal memory and/or an external memory.

For example, the internal memory may include at least one of a volatile memory (for example, DRAM, SRAM, or SDRAM), a nonvolatile memory (for example, one time programmable ROM (OTPROM), a PROM, an EPROM, an EEPROM, a mask ROM, a flash ROM, a flash memory, a hard drive, or a solid state drive (SSD)).

The external memory may include a flash drive, for example, a compact flash (CF), a secure digital (SD), a micro-SD, a mini-SD, an extreme digital (xD), a multi-media card (MMC), or a memory stick.

The storage module included in the learning model recommendation device may be defined as the first storage module 120, and the storage module included in the monitoring device 300 may be defined as the second storage module 360.

Hereinafter, the learning model recommendation method and the monitoring method implemented by the respective modules will be described in detail.

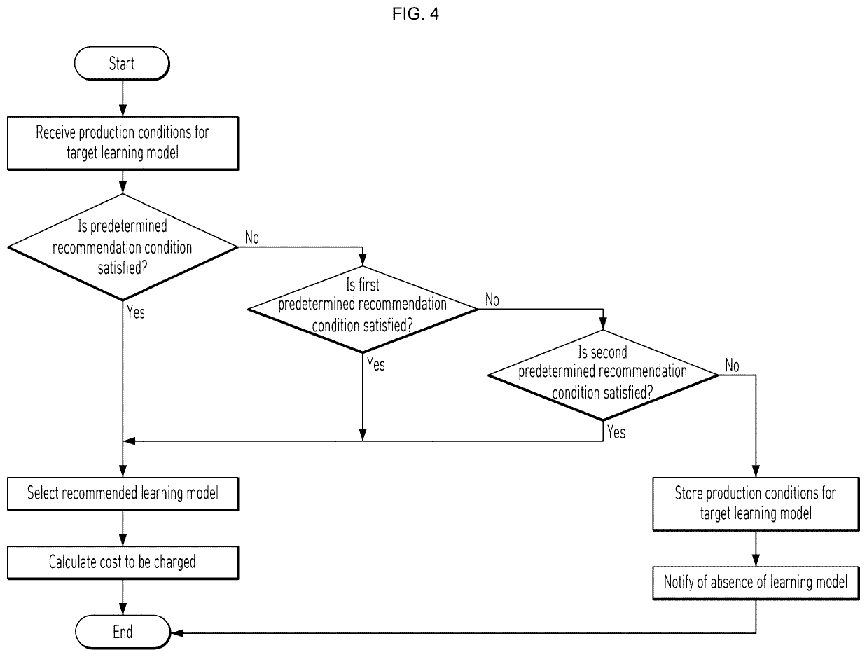

FIG. 4 illustrates a flowchart showing a learning model recommendation method implemented by the learning model recommendation device of the cloud integrated operation system according to the embodiment of the present invention.

Hereinafter, detailed description thereof may be omitted as long as the description overlaps the above-described content.

Referring to FIG. 4, a learning model recommendation method according to an embodiment of the present invention is implemented by the learning model recommendation device, and is a learning model recommendation method of recommending a learning model produced by machine learning or deep learning in response to a request from a demander and may include a request receiving step of receiving, by a reception module, a request from the demander and production conditions for a target learning model, which is a learning model requested by the demander, a condition storage step of storing, by a storage module, a stored learning model which is a learning model created in the past and production conditions for the stored learning model, a degree-of-similarity determination step of determining, by a degree-of-similarity determination module, a degree of similarity between the target learning model and the stored learning model, and a recommendation step of recommending, by a recommendation module, a learning model satisfying a predetermined recommendation condition among the stored learning models stored in the storage module to the demander.

Here, the recommendation step may be a step of selecting or producing a learning model to be recommended to the demander by determining whether a first predetermined additional condition determined to be satisfied based on a second degree of similarity lower than the first degree of similarity and a second predetermined additional condition determined to be satisfied based on a virtual learning model created by combining a plurality of stored learning models are satisfied, even when the pre-stored learning model is not satisfied.

The demander may input the production conditions for the target learning model through an interface received from the interface module using the computing device.

The collection module may receive the production conditions for the target learning model from the computing device of the demander and transmit the production conditions to the degree-of-similarity determination module.

The degree-of-similarity determination module may determine the degree of similarity between the target learning model and the stored learning model stored in the storage module.

The degree-of-similarity determination module may transfer a result of the degree-of-similarity determination between the target learning model and the stored learning model to the recommendation module.

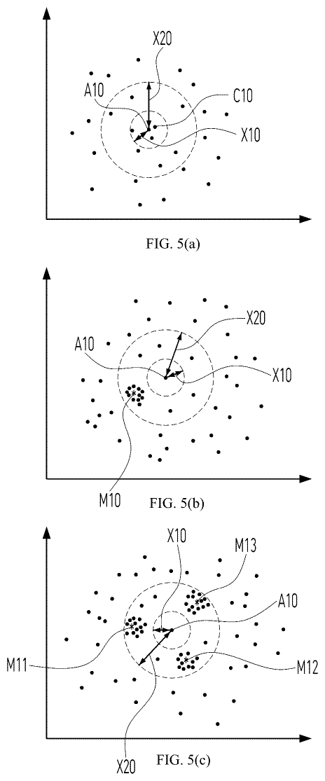

FIG. 5 is a diagram illustrating the predetermined recommendation condition and the first predetermined additional condition in the learning model recommendation method according to the embodiment of the present invention.

Referring to FIGS. 4 and 5(a), the recommendation module may determine whether there is the stored learning model that satisfies the predetermined recommendation condition.

The predetermined recommendation condition may be a condition under which the stored learning model is similar to the target learning model with a degree of similarity equal to or higher than a first degree of similarity.

Being similar to the first degree of similarity or higher may mean that the stored learning model exists at a first distance X10 or less from a target learning model A10.

When there are a plurality of stored learning models that satisfy the predetermined recommendation condition, the recommendation module may select the stored learning model that is most similar to the target learning model as a recommended learning model C10.

Even when there is no stored learning model that satisfies the predetermined recommendation condition, the recommendation module may produce the recommended learning model according to a predetermined production method when the first predetermined additional condition is satisfied.

The first predetermined additional condition may be a condition under which the stored learning model is similar to the target learning model with a degree of similarity equal to or higher than the second degree of similarity and lower than the first degree of similarity, and the number of clusters of stored learning models similar to the target learning model with a degree of similarity equal to or lower than the second degree of similarity is equal to or smaller than a predetermined number.

This may be intended for supplementation and correction when the production conditions for the target learning model are not accurately designated due to the immaturity of the demander.

Referring to FIGS. 5(b) and 5(c), the first predetermined additional condition may be satisfied with the number the clusters of stored learning models are 1 and 3.

Here, the cluster may be defined as being formed when the number of stored learning models within a predetermined distance from a center point of the cluster is a predetermined number or more.

Here, the predetermined distance and the predetermined number may be changed in various ways at a level that is obvious to those skilled in the art.

The predetermined production method may be a method of selecting the stored learning model closest to an average of the cluster as the recommended learning model when there is one cluster of stored learning models similar to the target learning model with a degree of similarity equal to or higher than the second degree of similarity.

Being similar with a degree of similarity equal to or higher than the second degree of similarity may mean that the stored learning model exists within a second distance X20 from the target learning model.

Referring to FIG. 5(b), one cluster may be formed within a distance exceeding the first distance X10 and equal to or smaller than the second distance X20.

The recommendation module may calculate the production conditions by performing inverse calculation on a vector of an average point M10 of one cluster within a distance greater than the first distance X10 and equal to or smaller than the second distance X20 with reference to the target learning model A10, and select the recommended learning model.

The predetermined production method may be a method of selecting the recommended learning model as a combination of the stored learning models closest to an average of each cluster when the number of clusters of the stored learning models similar to the target learning model with a degree of similarity equal to or higher than the second degree of similarity is larger than 1 and equal to or smaller than a predetermined number.

Referring to FIG. 5(c), three clusters may be formed within a distance greater than the distance X20 and equal to or smaller greater than the first distance X10 from the target learning model A10.

For example, average points M11 of the production conditions for the stored learning model forming a first cluster, average points M12 of the production conditions for the stored learning model forming a second cluster, and average points M13 of the stored learning model forming a third cluster may be subjected to weighted averaging depending on distances so that a production condition can be calculated.

Here, the smaller the distance to the target learning model is, the higher the weight may be.

For example, when a distance between the average point M11 of the production conditions of the stored learning model forming the first cluster and the target learning model is ‘10’, a distance between the average point M12 of the production conditions of the stored learning model forming the second cluster and the target learning model is ‘20’, and a distance between the average point M13 of the production conditions of the stored learning model forming the third cluster and the target learning model is ‘30’, weights for the first cluster, the second cluster, and the third cluster may be set to 3:2:1 so that the above-described production condition can be calculated.

Thus, the recommendation module the recommendation module may perform inverse calculation on the vector of the calculated average value to produce the production conditions, and select the recommended learning model.

The vectorization along two axes has been illustrated in FIG. 5, but the present invention is not limited thereto, and the production conditions may be vectorized along three axes, the degree of similarity may be determined, and whether the above-described conditions are satisfied may be determined.

The recommendation module may select the recommended learning model based on the stored learning models that satisfy the second predetermined additional condition even when the predetermined recommendation condition and the first predetermined additional condition are not satisfied.

As a specific example, the recommendation module may select the virtual learning model that satisfies the second predetermined additional condition as the recommended learning model based on the virtual learning model received from the simulation module.

When there is no stored learning model that satisfies the predetermined recommend condition, the first predetermined additional condition, and the second predetermined additional condition, the learning proposal module may store the production conditions for the target learning model.

Further, the interface model may produce an interface for displaying to the demander a message indicating that there is no stored learning model similar to the target learning model, and transmit the interface to the computing device of the demander.

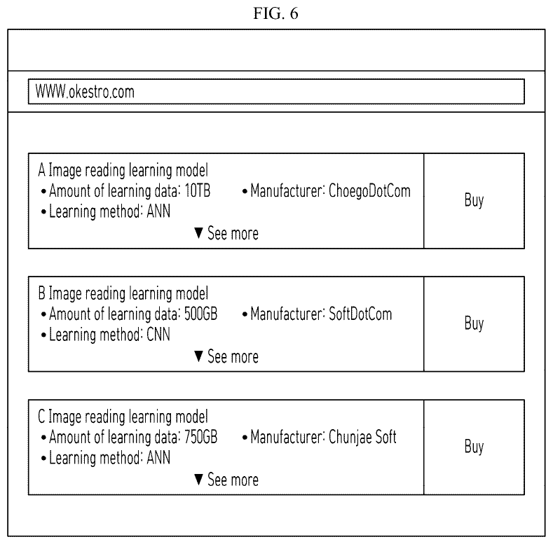

FIG. 6 is a diagram illustrating a learning model mediation interface screen that is provided by the interface module of the learning model recommendation device according to the embodiment of the present invention.

Referring to FIG. 6, the interface module may produce an interface for the learning model mediation platform that mediates between a seller who creates and sells a learning model and a buyer who purchases the learning model.

For example, specifications (production conditions) of the learning model created by the seller may be listed, and a price thereof may be determined and displayed on the interface.

Here, the demander may select, purchase, rent, and use the learning model required for a program of the demander as if the demander is shopping online.

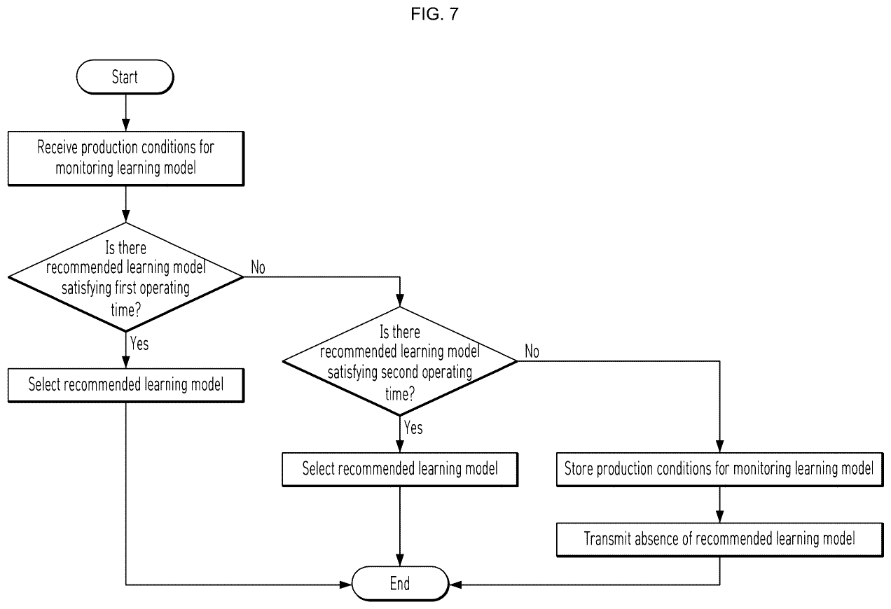

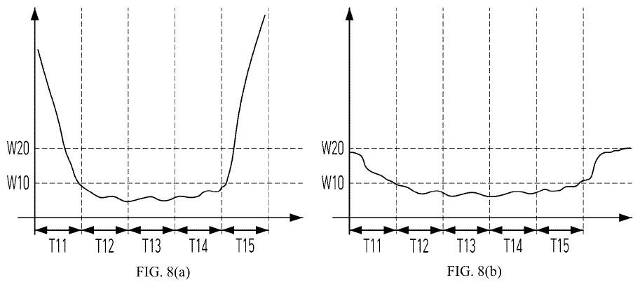

FIG. 7 is a flowchart illustrating a process in which the learning model recommendation device according to the embodiment of the present invention selects the learning model to be recommended to the monitoring device, and FIG. 8 is a diagram illustrating a method in which the model selection module of the monitoring device according to the embodiment of the present invention calculates a first operating time and a second operating time.

Referring to FIGS. 7 and 8, the model selection module may transmit the first operating time and the second operating time when transmitting the production conditions to the learning model recommendation device.

The model selection module may calculate the first operating time and the second operating time while determining the operating time.

The first operating time may be a total time of a continuous partition period in which the average usage resources of the cloud integrated operation system are generated at the first proportion or less.

The second operating time may be a time in which the average usage resources of the cloud integrated operation system are generated and that is a sum of the first operating time and a total continuous time adjacent to the first operating time.

Referring to FIG. 8(a), for example, when the partition period is in units of hours, a period in which the average usage resources of the cloud integrated operation system are expected to be produced at the first proportion W10 or less may be the operating times T12, T13, and T14, and the first operating time may be 3 hours.

Here, since the average usage resources of the partition period T11 and T15 adjacent to the operating time are higher than a second proportion W20, there may be no second operating time.

Referring to FIG. 8(b), for example, when the partition period is in units of hours, a period in which the average usage resources of the cloud integrated operation system are expected to be produced at the first proportion W10 or less may be the operating times T12, T13, and T14, and the first operating time may be 3 hours.

Further, since the average usage resources of the partition period T11 and T15 adjacent to the operating time are lower than the second proportion W20, the second operating time may be 5 hours, which is a sum of the first operating time and 2 hours.

The second operating time may be a period in which the learning model can be operated within an allowable range, although the operating time may place some strain on the cloud integrated operation system.

The learning model recommendation device may receive a request to recommend the learning model, the production conditions, and the first and second operating times, directly from the monitoring device or from the intermediate module.

Among the content described above, the target learning model can be understood as the monitoring learning model to be recommended.

The learning model recommendation device may determine whether there is the stored learning model similar to the monitoring learning model for which the recommendation has been requested, as described above, and detailed description thereof may be omitted as long as the description overlaps the above-described content.

However, when the learning model is recommended internally in the system, the operating time may be further considered to determine whether there is a recommended learning model, unlike the recommendation scheme described above.

The simulation module may simulate a time required when the stored learning model stored in the first storage module is operated.

Here, an amount of data expected to be input may be received together when the production conditions are received from the monitoring device.

The simulation module may transfer an expected operating time of the stored learning model to the recommendation module.

The recommendation module may determine whether there is a stored learning model that satisfies the predetermined recommendation condition, the first predetermined additional condition, or the second predetermined additional condition among the stored learning modules that satisfies the first operating time. Detailed description thereof may be omitted as long as the description overlaps the above-described content.

Here, the expected operating time of the stored learning module that satisfies the second predetermined additional condition may be calculated by adding up expected operating times of all the stored learning models that are utilized (for example, the start stored learning model and the end stored learning model).

When there is no stored learning model that satisfies the predetermined recommendation condition, the first predetermined additional condition, or the second predetermined additional condition among the stored learning modules that satisfies the first operating time, the recommendation module may determine whether there is a stored learning model that satisfies the predetermined recommendation condition, the first predetermined additional condition, or the second predetermined additional condition among the stored learning modules that satisfies the second operating time. Detailed description thereof may be omitted as long as the description overlaps the above-described content.

Here, the expected operating time of the stored learning module that satisfies the second predetermined additional condition may be calculated by adding up the expected operating times of all the stored learning models that are utilized (for example, the start stored learning model and the end stored learning model).

When there is no stored learning model that satisfies the predetermined recommendation condition, the first predetermined additional condition, or the second predetermined additional condition within the first operating time and the second operating time, the absence of the recommended learning model may be transferred to the model selection module, and the production conditions for the monitoring learning model may be stored in the learning proposal module and utilized for the learning described above.

The model selection module may select the recommended learning model received from the learning model recommendation device as the monitoring learning model and transfer the recommended learning model to the model operating module.

A monitoring method according to an embodiment of the present invention is a monitoring method for monitoring an operation of at least one virtual machine operated on a physical server within allocated resources of a cloud integrated operation system through a monitoring device, the monitoring method including: collecting, by a transmission and reception module, operating information generated in the virtual machine; monitoring, by a monitoring module, whether the virtual machine operates abnormally based on the operating information; operating, by a model operating module, a monitoring learning model that assists in a monitoring function of the monitoring module in response to a request from the monitoring module; and determining, by a schedule module, an operating time of the monitoring learning model through a predetermined time determination method so that the monitoring learning model can be operated within allocated resources.

Further, the monitoring method may further include a step of determining, by the schedule module, the operating time based on a load (usage resources) predicted by the first monitoring learning model that predicts a load generated in the cloud integrated operation system during the predetermined future period.

Further, the monitoring method may further include a step of selecting, by the model selection module, a monitoring learning model satisfying a predetermined operation condition.

Further, the monitoring method may further include a step of changing, by the model selection module, the predetermined threshold based on the load predicted by the first monitoring learning model.

In the accompanying drawings, in order to express the technical spirit of the present invention more clearly, components not related to or far from the technical spirit of the present invention are briefly expressed or omitted.

Although the configuration and features of the present invention have been described based on the embodiments according to the present invention, the present invention is not limited thereto, it is obvious to those skilled in the art that various changes or modifications can be made within the spirit and scope of the present invention, and therefore, it is stated that such changes or modifications fall within the attached claims.

1. A monitoring device for monitoring an operation of at least one virtual machine operated on a physical server within allocated resources of a cloud integrated operation system, the monitoring device comprising:
a transmission and reception module configured to collect operating information generated in the virtual machine;
a monitoring module configured to monitor whether the virtual machine operates abnormally based on the operating information collected by the transmission and reception module;
a model operating module configured to operate a monitoring learning model that assists in a monitoring function of the monitoring module in response to a request from the monitoring module; and
a schedule module configured to determine an operating time of the monitoring learning model through a predetermined time determination method so that the monitoring learning model can be operated within the allocated resources.

2. The monitoring device of claim 1, wherein
the monitoring learning model includes a first monitoring learning model configured to predict a load generated in the cloud integrated operation system during the predetermined future period, and
the schedule module determines the operating time based on the load predicted by the first monitoring learning model.

3. The monitoring device of claim 2, wherein the predetermined time determination method is a method of determining the operating time at a time when the load is generated at or below a predetermined proportion of the allocated resources.

4. The monitoring device of claim 3, wherein the predetermined time determination method is a method of determining the operating time at a time when the lowest load is generated in the predetermined future period.

5. The monitoring device of claim 1, further comprising:
a model selection module configured to select the monitoring learning model that satisfies a predetermined operating condition,
wherein the predetermined operating condition is a condition of an operation in which a load lower than a predetermined threshold is applied.

6. The monitoring device of claim 5, wherein
the learning model includes a first monitoring learning model configured to predict a load generated in the cloud integrated operation system during the predetermined future period, and
the schedule selection module changes the predetermined threshold based on the load predicted by the first monitoring learning model.

7. A cloud integrated operation system comprising:
a management device configured to manage a virtual machine operated on a physical server;
a monitoring device configured to monitor an operation of the virtual machine; and
a learning model recommendation device configured to recommend a monitoring learning model required for the monitoring device to implement a monitoring function,
wherein the monitoring device includes a transmission and reception module configured to collect information generated in the virtual machine, a monitoring module configured to monitor whether the virtual machine operates abnormally based on the information of the virtual machine collected by the transmission and reception module, a model operating module configured to operate the monitoring learning model that assists in a monitoring function of the monitoring module in response to a request from the monitoring module, a schedule module configured to determine an operating time of the monitoring learning model through a predetermined time determination method so that the monitoring learning model can be operated within allocated resources, and a model selection module configured to select the monitoring learning model that is operated in the model operating module that satisfies predetermined operation conditions,
the model selection module requests the learning model recommendation device to recommend the monitoring learning model that satisfies the predetermined operation conditions, and
the learning model recommendation device recommends a learning model that satisfies predetermined recommendation conditions under which a pre-stored learning model is similar to the monitoring learning model with a degree of similarity equal to or higher than a first degree of similarity among pre-stored learning models.

8. The cloud integrated operation system of claim 7, wherein the learning model recommendation device recommends a learning model that satisfies a first predetermined additional condition determined to be satisfied based on a second degree of similarity lower than the first degree of similarity or a second predetermined additional condition determined to be satisfied based on a virtual learning model created by combining a plurality of stored learning models, even when there is no learning model satisfying the pre-stored learning model among the pre-stored stored learning models.

9. The cloud integrated operation system of claim 8, wherein the first predetermined additional condition is a condition under which the stored learning model is similar to the monitoring learning model with a degree of similarity equal to or higher than the second degree of similarity and lower than the first degree of similarity, and the number of clusters of pre-stored learning models similar to the monitoring learning model with a degree of similarity lower than the second degree of similarity is equal to or smaller than a predetermined number.

10. A monitoring method for monitoring an operation of at least one virtual machine operated on a physical server within allocated resources of a cloud integrated operation system through a monitoring device, the monitoring method comprising:
collecting, by a transmission and reception module, operating information generated in the virtual machine;
monitoring, by a monitoring module, whether the virtual machine operates abnormally based on the operating information;
operating, by a model operating module, a monitoring learning model that assists in a monitoring function of the monitoring module in response to a request from the monitoring module; and
determining, by a schedule module, an operating time of the monitoring learning model through a predetermined time determination method so that the monitoring learning model can be operated within allocated resources.
